(19) United States
(12) Patent Application Publication
(10) Pub. No.: US 2016/0054244 A1
(43) Pub. Date: Feb. 25, 2016

(54) FILM-FORMING AND ANALYSIS COMPOSITE APPARATUS, METHOD FOR CONTROLLING FILM-FORMING AND ANALYSIS COMPOSITE APPARATUS, AND VACUUM CHAMBER

(71) Applicant: Sharp Kabushiki Kaisha, Osaka (JP)

(72) Inventor: Atsushi NIINOH, Osaka-shi (JP)

(21) Appl. No.: 14/816,169

(22) Filed: Aug. 3, 2015

(30) Foreign Application Priority Data
Aug. 25, 2014 (JP) 2014-170947

(51) Int. Cl. G01N 23/227

(52) U.S. Cl. CPC G01N 23/2273; G01N 2223/6116

(57) ABSTRACT

A vacuum chamber is provided with a film-forming apparatus which film-forms an oxide semiconductor thin film by sputtering, an analysis apparatus which performs spectroscopic analysis with respect to a surface of the film-formed oxide semiconductor thin film, and a valve which splits an inner space of the vacuum chamber into a first space where the analysis apparatus is arranged and a second space where the film-forming apparatus is arranged and permits communication between the split first space and second space.

### BACKGROUND

1. Field

The present disclosure relates to a film-forming and analysis composite apparatus in which a film-forming apparatus and an analysis apparatus are combined.

2. Description of the Related Art

In recent years, active matrix type liquid crystal display apparatuses where a thin film transistor (TFT) is arranged in each pixel of a liquid crystal display apparatus have been widely used.

In addition, hydrogenated amorphous silicon (a-Si:H), low temperature poly silicon (LTPS), and the like have been mainly used as the semiconductor material of the TFT.

However, there are problems in that mobility is small in a-Si:H and local non-uniformity which occurs during crystallization is generated in LTPS. For this reason, oxide semiconductors which are represented by oxides which include indium (In), gallium (Ga), and zinc (Zn) have recently attracted attention. Using these oxide semiconductors, it is possible to obtain high mobility even at room temperature.

On the other hand, it is known that the film quality such as the composition ratio or the bonding state of an oxide semiconductor thin film has a major influence on the thin film transistor (TFT) characteristics (in particular, the electrical characteristics) in a case of using an oxide semiconductor thin film as a TFT active layer. For this reason, various techniques for inspecting information about an oxide semiconductor thin film (for example, the mobility or film-forming state) have been proposed.

Japanese Unexamined Patent Application Publication No. 2012-33857 (published on Feb. 16, 2012) discloses a method for evaluating the mobility of an oxide semiconductor thin film without contact by irradiating a sample, on which an oxide semiconductor thin film is film-formed, with excitation light and microwaves.

In addition, Japanese Unexamined Patent Application Publication No. 2003-201562 (published on Jul. 18, 2003) discloses a method for monitoring a film-forming state of an oxide semiconductor thin film by monitoring the state of plasma for sputtering a target during the film-forming of the oxide semiconductor thin film of a semiconductor device such as a metal oxide semiconductor (MOS) transistor.

However, with the method according to Japanese Unexamined Patent Application Publication No. 2012-33857, in a case of determining that an abnormality is generated in the mobility of an oxide semiconductor thin film, it is not possible to determine whether the abnormality is generated (i) due to deviation in the composition ratio of the oxide semiconductor thin film or (ii) due to an abnormality in the bonding state. That is, there is a problem in that it is not possible to obtain accurate information about the oxide semiconductor thin film to the extent of being able to specify the cause of an abnormality.

Furthermore, since a sample, on which an oxide semiconductor thin film is film-formed, has to be exposed to the atmosphere at least once during evaluation, there is also a problem in that it is not possible to obtain accurate information about the oxide semiconductor thin film in a case where the surface of the oxide semiconductor thin film is contaminated. Furthermore, there is a problem in that it is not possible to quickly obtain information about the oxide semiconductor thin film.

In addition, with the method according to Japanese Unexamined Patent Application Publication No. 2003-201562, it is not possible to directly monitor the film composition of the film-formed oxide semiconductor thin film and it is not possible to discover whether the composition is minutely changed in the film-formed oxide semiconductor thin film. That is, there is a problem in that it is not possible to obtain accurate information about the oxide semiconductor thin film.

Thus, with the methods according to Japanese Unexamined Patent Application Publication No. 2012-33857 and Japanese Unexamined Patent Application Publication No. 2003-201562, there is a problem in that it is not possible to quickly and accurately obtain information about a sample (in particular, oxide semiconductor thin films).

### SUMMARY

It is desirable to provide a film-forming and analysis composite apparatus with which it is possible to quickly and accurately obtain information about a sample.

According to an aspect of the disclosure, there is provided a film-forming and analysis composite apparatus having a function as a vacuum chamber which can make an inner space thereof a vacuum, the apparatus including a film-forming apparatus which film-forms a sample by sputtering, an analysis apparatus which performs spectroscopic analysis with respect to a surface of the film-formed sample, and an interrupting member which splits the inner space into a first space where the analysis apparatus is arranged and a second space where the film-forming apparatus is arranged and permits communication between the split first space and second space.

In addition, according to an aspect of the disclosure, there is provided a vacuum chamber which can make an inner space thereof a vacuum, including an interrupting member which splits the inner space into a first space where a film-forming apparatus which film-forms a sample by sputtering is arranged and a second space where an analysis apparatus which performs spectroscopic analysis with respect to a surface of the film-formed sample is arranged, and permits communication between the split first space and second space.

### BRIEF DESCRIPTION OF THE DRAWINGS

FIG. 1 is a diagram which shows a configuration of a vacuum chamber according to Embodiment 1 of the disclosure;

FIG. 2 is a diagram which illustrates energy bands of electrons in X-ray photoelectron spectroscopy (XPS);

FIG. 3 is a diagram which shows an example of an XPS spectrum;

FIG. 4 is a diagram which shows an example of an XPS spectrum of In at a normal time and at an abnormal time;

FIGS. 5A and 5B are diagrams which show a detailed configuration of a valve and the periphery thereof in the vacuum chamber according to Embodiment 1 of the disclosure;

FIG. 5A is a diagram which shows a state where the valve is closed; and FIG. 5B is a diagram which shows a state where the valve is opened;

FIGS. 6A to 6D are diagrams which illustrate each step of film-forming and analysis of an oxide semiconductor thin film in the vacuum chamber according to Embodiment 1 of the disclosure;

FIG. 7 is a diagram which illustrates a flow of each step of film-forming and analysis of an oxide semiconductor thin film in the vacuum chamber according to Embodiment 1 of the disclosure;

FIG. 8 is a diagram which shows a configuration of a vacuum chamber according to Embodiment 2 of the disclosure;

FIGS. 9A and 9B are diagrams which illustrate each step of film-forming and analysis of an oxide semiconductor thin film in the vacuum chamber according to Embodiment 2 of the disclosure and FIG. 9C is an enlarged diagram of a region of a part of FIG. 9A;

FIG. 10 is a diagram which shows a configuration of a vacuum chamber according to Embodiment 3 of the disclosure;

FIGS. 11A to 11C are diagrams which illustrate energy bands of electrons in Auger electron spectroscopy (AES);

FIG. 12 is a diagram which shows an example of an AES spectrum;

FIGS. 13A and 13B are diagrams which show an example of an AES spectrum of In at a normal time and at an abnormal time;

FIGS. 14A and 14B are diagrams which illustrate each step of film-forming and analysis of an oxide semiconductor thin film in the vacuum chamber according to Embodiment 3 of the disclosure;

FIG. 15 is a diagram which illustrates a flow of each step of film-forming and analysis of an oxide semiconductor thin film in the vacuum chamber according to Embodiment 3 of the disclosure;

FIG. 16 is a diagram which shows a configuration of a vacuum chamber according to Embodiment 4 of the disclosure;

FIGS. 17A and 17B are diagrams which illustrate each step of film-forming and analysis of an oxide semiconductor thin film in the vacuum chamber according to Embodiment 4 of the disclosure and FIG. 17C is an enlarged diagram of a region of a part of FIG. 17A;

FIG. 18 is a diagram which illustrates a flow of steps for production and evaluation of a TFT in a comparative example; and

FIGS. 19A and 19B are diagrams which illustrate electrical characteristics (I-V characteristics) of a TFT in the comparative example; FIG. 19A is a diagram which shows electrical characteristics of a favorable TFT; and FIG. 19B is a diagram which shows electrical characteristics of a defective TFT.

### DESCRIPTION OF THE EMBODIMENTS

### Embodiment 1

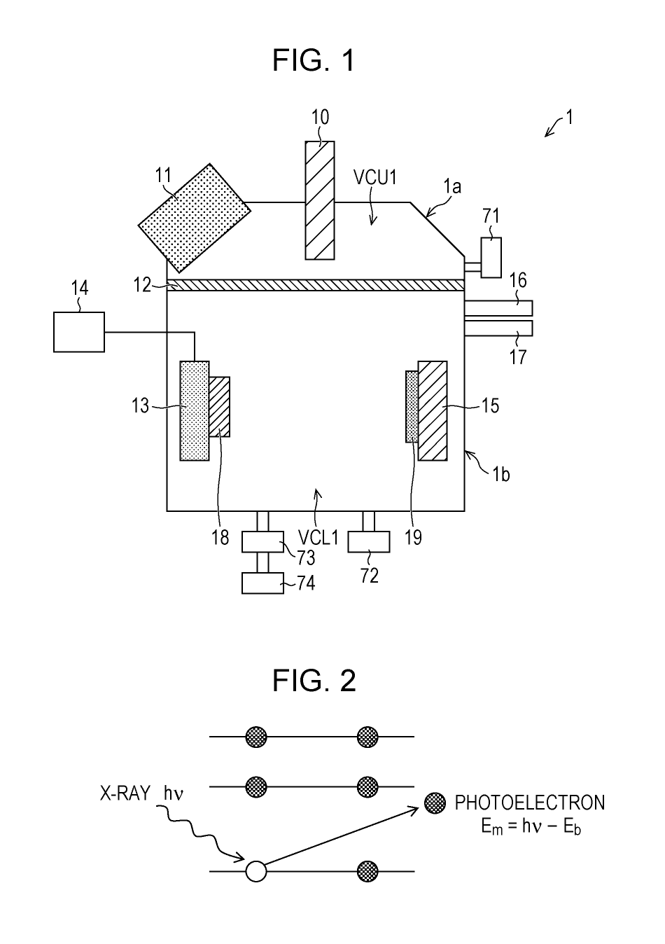

Description will be given of Embodiment 1 of the disclosure based on FIG. 1 to FIG. 7.

### Configuration of Vacuum Chamber 1

FIG. 1 is a diagram which shows a configuration of a vacuum chamber 1 (a film-forming and analysis composite apparatus) of the present embodiment. As described below, the vacuum chamber 1 is configured as a film-forming and analysis composite apparatus in which an analysis apparatus 1a and a film-forming apparatus 1b are combined.

Accordingly, it may be understood that the vacuum chamber 1 of the present embodiment is a film-forming and analysis composite apparatus having a function as a vacuum chamber which can make an inner space thereof a vacuum.

The vacuum chamber 1 is configured so as to be able to film-form an oxide semiconductor thin film (a sample) and perform spectroscopic analysis using X-ray photoelectron spectroscopy (XPS) with respect to the oxide semiconductor thin film. The vacuum chamber 1 is provided with the analysis apparatus 1a, the film-forming apparatus 1b, and a valve 12 (an interrupting member).

Here, in the present embodiment, description is given of an example of a case where the analysis target of the vacuum chamber 1 is an oxide semiconductor thin film; however, the analysis target has not to be limited only to oxide semiconductor thin films.

In detail, arbitrary samples capable of being film-formed by the film-forming apparatus 1b and capable of being analyzed by the analysis apparatus 1a may be included in the analysis targets of the vacuum chamber 1. Representative examples of samples other than an oxide semiconductor thin film include conductive films such as an ITO film where tin is added to indium oxide and an IZO film where zinc is added to indium oxide, insulating films such as a silicon oxide film and a silicon nitride film, and the like.

The analysis apparatus 1a is provided with an X-ray source 10 (an inspection radiation source), a photoelectron detector 11 (an electron detector), and an ion pump 71. In addition, the film-forming apparatus 1b is provided with a substrate holder 13, a position adjusting mechanism 14, a sputtering electrode 15, an argon gas introducing pipe 16, an oxygen gas introducing pipe 17, an ion pump 72, a turbo-molecular pump 73, and a rotary pump 74.

In the film-forming apparatus 1b, a substrate 18 is arranged on the substrate holder 13. As described below, an oxide semiconductor thin film is film-formed on a surface of the substrate 18. The substrate holder 13 is provided in order to hold the substrate 18.

The film-forming apparatus 1b film-forms a sample which is to be the target of spectroscopic analysis. In addition, the analysis apparatus 1a carries out spectroscopic analysis on the surface of the sample which is film-formed by the film-forming apparatus. In this manner, the vacuum chamber 1 is configured as a film-forming and analysis composite apparatus in which a film-forming apparatus and an analysis apparatus are combined.

The position adjusting mechanism 14 is provided in order to change the position of the substrate holder 13 which holds the substrate 18. The position adjusting mechanism 14 may be realized, for example, by a servo actuator (a servo mechanism) for which rotational motion and motion in a horizontal direction are possible.

In addition, a sputtering target 19 is arranged at the sputtering electrode 15. As described below, sputtering where an oxide semiconductor thin film is film-formed (deposited) on the surface of the substrate 18 is performed by applying a high voltage to the sputtering electrode 15 after placing the substrate 18 to oppose the sputtering target 19 using the position adjusting mechanism 14.

The argon gas introducing pipe 16 and the oxygen gas introducing pipe 17 are provided in order to introduce argon and oxygen, which are sputtering gases, to the inside of the vacuum chamber 1.

Then, as shown in FIG. 1, it is possible to divide a space in the inside of the vacuum chamber 1 into two spaces of a first space VCU 1 (a second space) and a second space VCL 1 (a first space). The first space VCU 1 is a space where the analysis apparatus 1a is provided. In addition, the second space VCL 1 is a space where the film-forming apparatus 1b is provided.

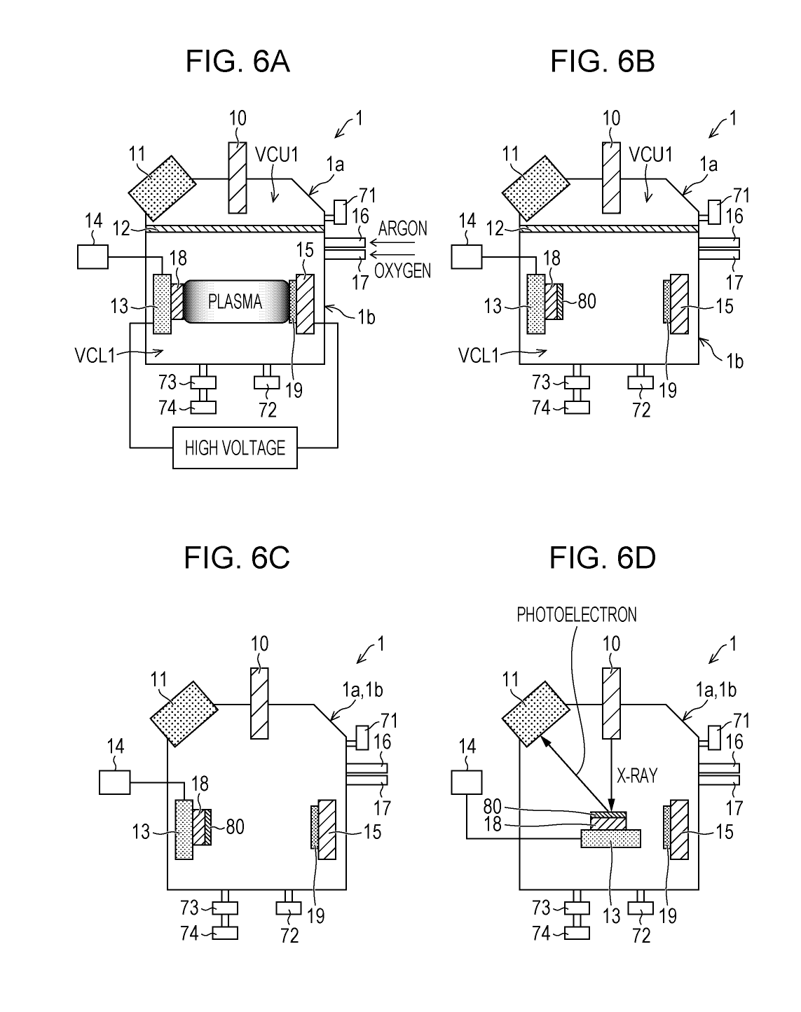

The ion pump 71 is provided in the analysis apparatus 1a as a vacuum pump for producing a vacuum in the first space VCU 1. The ion pump 71 operates all times in order to vacuum the first space VCU 1 before starting each step of film-forming and analyzing an oxide semiconductor thin film (refer to FIGS. 6A to 6D which will be described below).

The ion pump 72, the turbo-molecular pump 73, and the rotary pump 74 are provided in the film-forming apparatus 1b as a vacuum pump for producing a vacuum in the second space VCL 1. The ion pump 72 functions as a pump for high vacuum evacuation in the film-forming apparatus 1b. In addition, the turbo-molecular pump 73 and the rotary pump 74 function as pumps for low and intermediate vacuum evacuation. For this reason, the operation state of the pumps may be appropriately adjusted according to the degree of vacuum which is desired for the second space VCL 1.

The X-ray source 10 irradiates an oxide semiconductor thin film (in other words, the sample which is the analysis target) with X-rays as inspection radiation. Photoelectrons are released from the surface of the oxide semiconductor thin film due to the oxide semiconductor thin film being irradiated with X-rays. The photoelectron detector 11 detects photoelectrons which are released from the surface of the oxide semiconductor thin film.

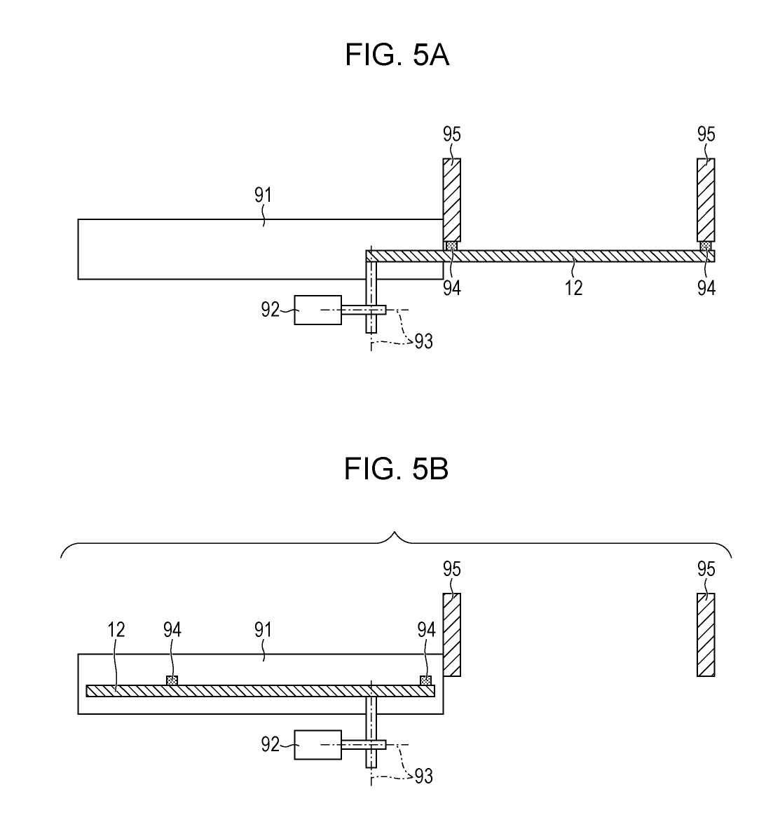

The valve 12 has a role of splitting the inner space of the vacuum chamber 1 into the first space VCU 1 and the second space VCL 1 and of permitting communication between the split first space VCU 1 and second space VCL 1. Detailed description will be given below of the valve 12 and the periphery thereof (refer to FIGS. 5A and 5B).

### XPS Principles

As described above, in the vacuum chamber 1, spectroscopic analysis using XPS is performed with respect to an oxide semiconductor thin film as a sample. Description will be briefly given below of the principles of XPS with reference to FIG. 2 to FIG. 4.

FIG. 2 is a diagram which illustrates energy bands of electrons in XPS. X-rays which are irradiated from the X-ray source 10 with respect to a sample have energy hν. Here, h is a Planck constant and ν is the frequency of the X-rays.

Then, photoelectrons which have a kinetic energy Eₘ are released to the outside of an electron orbit due to orbital electrons (photoelectrons) of atoms which configure a sample being excited by the X-rays. Here, the kinetic energy Eₘ is represented as Eₘ=hν−E_{b}. Here, E_{b} is the binding energy (orbital binding energy) of a photoelectron.

As a result, photoelectrons which are present in the vicinity of the surface of the sample (a position of a depth up to approximately 6 nm from the surface of the sample) are released from the surface of the sample. Then, the released photoelectrons are detected by the photoelectron detector 11.

Accordingly, when the energy (hν) of the X-rays with which the sample is irradiated is known, it is possible to specify the binding energy E_{b} of the photoelectrons in the sample by analyzing the energy (Eₘ) of the photoelectrons which are detected by the photoelectron detector 11.

Then, it is possible to specify the elements which configure the sample by referring to the binding energy E_{b} of the photoelectrons. Furthermore, there are cases where it is also possible to analyze a bonding state of the elements by referring to the binding energy E_{b} of the photoelectrons depending on the elements or the electron orbit.

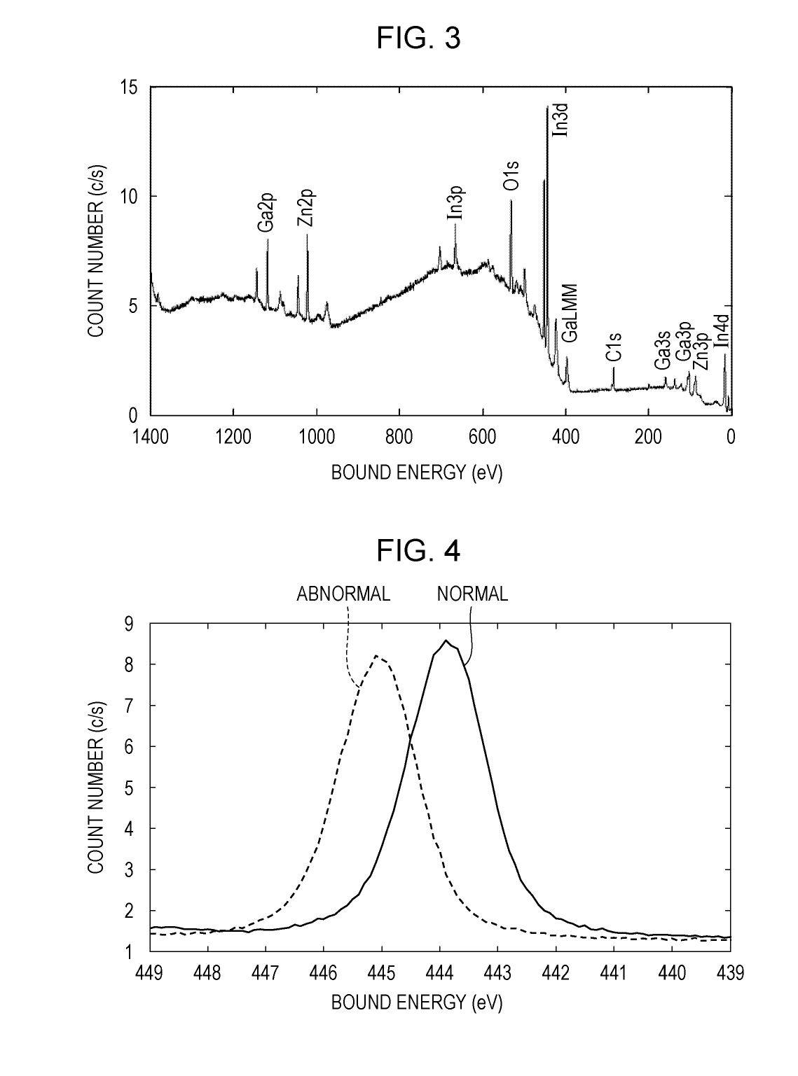

In detail, the spectrum (XPS spectrum) of the photoelectrons is analyzed in the XPS. FIG. 3 is a graph which shows an example of the XPS spectrum. The horizontal axis of the graph represents the binding energy (unit: eV) of a photoelectron and the vertical axis of the graph represents a count number (unit: c/s) of photoelectrons per second.

In addition, FIG. 4 is a graph which shows an example of an XPS spectrum of In at a normal time and at an abnormal time. In the same manner as FIG. 3, in FIG. 4, the horizontal axis of the graph also represents the binding energy of the photoelectrons and the vertical axis of the graph also represents a count number of photoelectrons per second.

As shown in FIG. 4, the peak positions of the XPS spectrum are different at a normal time and at an abnormal time. In other words, the peak position of the XPS spectrum at an abnormal time is shifted from the peak position at a normal time.

For this reason, when a value of binding energy at which a peak of a count number is generated is known for each element at a normal time, it is possible to specify which of the elements an abnormality is generated in by referring to the shift of the peak position.

### Detailed Configuration of Valve 12 and Periphery

FIGS. 5A and 5B are diagrams which show a detailed configuration of the valve 12 and the periphery thereof. FIG. 5A shows a state where the valve 12 is closed (a state where the first space VCU 1 and the second space VCL 1 are split) and FIG. 5B shows a state where the valve 12 is opened (a state where communication is permitted between the first space VCU 1 and the second space VCL 1).

The valve 12 is provided so as to be able to be stored in a valve box 91 which is provided in the inside of the vacuum chamber 1. As shown in FIG. 5A, in a case where the valve 12 is closed, the valve 12 is positioned so as to protrude from the inside of the valve box 91 to the outside. On the other hand, as shown in FIG. 5B, in a case where the valve 12 is opened, the valve 12 is stored in the inside of the valve box 91.

In addition, the valve 12 and the valve box 91 are connected with a cylinder 92 via a rotary shaft 93. The operation of opening and closing the valve 12 is performed by rotating the cylinder 92 and driving the rotary shaft 93.

In addition, an O ring 94 is provided in the valve 12. As shown in FIG. 5A, in a case where the valve 12 is closed, the valve 12 comes into contact with an inner wall 95 of the vacuum chamber 1 via the O ring 94.

By providing the O ring 94, it is possible to avoid occurrence of a gap between the valve 12 and the inner wall 95 and it is possible to more reliably split the space into the first space VCU 1 and the second space VCL 1 using the valve 12.

In this manner, the valve 12 has a function of splitting (separating) a space in the inside of the vacuum chamber 1 and sealing the split spaces. Here, the structure of the valve 12 may be a gate valve with a rotary orbit structure which is shown in FIGS. 5A and 5B or may be another appropriate structure.

In addition, the material of the valve 12 may be, for example, stainless steel, aluminum, or the like. That is, it is sufficient if the material of the valve 12 is not easily affected by sputtering gas (oxygen or the like) and has sufficient mechanical strength.

Each Step from Film-Forming to Analysis of Oxide Semiconductor Thin Film in Vacuum Chamber 1

FIGS. 6A to 6D are diagrams which illustrate each step (a first step to a fourth step) of film-forming and analysis of an oxide semiconductor thin film in the vacuum chamber 1. Description will be given below of the steps with reference to FIGS. 6A to 6D.

In the first step, the position of the substrate holder 13 is changed by the position adjusting mechanism 14 and the substrate 18 is arranged so as to oppose the sputtering target 19. Here, before the first step, the valve 12 is closed and the first space VCU 1 and the second space VCL 1 are split (splitting step). Here, a vacuum is produced in each of the first space VCU 1 and the second space VCL 1 beforehand.

A state where the substrate 18 opposes the sputtering target 19 (a state where the first step is completed) is illustrated in FIG. 1 described above.

Subsequently, in the second step, argon and oxygen which are sputtering gases are introduced to the second space VCL 1 by the argon gas introducing pipe 16 and the oxygen gas introducing pipe 17.

Then, a high voltage is generated between the substrate 18 and the sputtering target 19 by applying a high voltage to the sputtering electrode 15. Due to this, as shown in FIG. 6A, plasma is generated between the sputtering target 19 and the substrate 18.

Then, as a result of sputtering using the plasma, as shown in FIG. 6B, an oxide semiconductor thin film 80 is film-formed on a surface of the substrate 18 (film-forming step). Here, by cancelling the application of the voltage to the sputtering electrode 15, the plasma disappears and the second step is completed.

FIG. 6A is a diagram which illustrates a state where plasma is generated between the sputtering target 19 and the substrate 18 in the second step. In addition, FIG. 6B is a diagram which shows a state where the oxide semiconductor thin film 80 is film-formed on a surface of the substrate 18 (a state where the second step is completed).

Subsequently, the introduction of sputtering gas from the argon gas introducing pipe 16 and the oxygen gas introducing pipe 17 to the second space VCL 1 is stopped in the third step. Then, a vacuum is produced in the second space VCL 1 until the atmospheric pressure in the inside of the second space VCL 1 is decreased to approximately 10⁻⁸ Pa to 10⁻⁹ Pa (vacuum producing step).

Then, after the production of the vacuum in the second space VCL 1 is completed, the valve 12 is opened and communication is permitted between the first space VCU 1 and the second space VCL 1 (permitting communication step). FIG. 6C is a diagram which shows a state where the valve 12 is opened (a state where the third step is completed) in the third step.

By producing a vacuum in the second space VCL 1 beforehand, it is possible to keep the sputtering gas which is used for sputtering from flowing from the second space VCL 1 into the first space VCU 1 when communication is permitted between the first space VCU 1 and the second space VCL 1. Therefore, it is possible to keep the X-ray source 10, the photoelectron detector 11, and a surface of the oxide semiconductor thin film 80 from being contaminated.

In addition, by producing a vacuum in the first space VCU 1, it is possible to remove gas which may influence the trajectory of X-rays which are irradiated from the X-ray source 10 from the first space VCU 1.

Subsequently, in the fourth step, the position of the substrate holder 13 is changed by the position adjusting mechanism 14 and the substrate 18 is arranged so as to oppose the X-ray source 10.

Then, the surface of the oxide semiconductor thin film 80 which is film-formed on the surface of the substrate 18 is irradiated with X-rays from the X-ray source 10. Due to this, as described above, photoelectrons are released from the surface of the oxide semiconductor thin film 80. Next, the photoelectrons which are released from the surface of the oxide semiconductor thin film 80 are detected by the photoelectron detector 11.

FIG. 6D is a diagram which shows a state where the surface of the oxide semiconductor thin film 80 is irradiated with X-rays from the X-ray source 10 and the photoelectrons which are released from the surface of the oxide semiconductor thin film 80 are detected by the photoelectron detector 11 in the fourth step.

Then, by analyzing an XPS spectrum of the photoelectrons which are detected in the fourth step, it is possible to obtain information about the composition ratio, the bonding state, or the like of the oxide semiconductor thin film 80 (analyzing step).

### Comparative Example

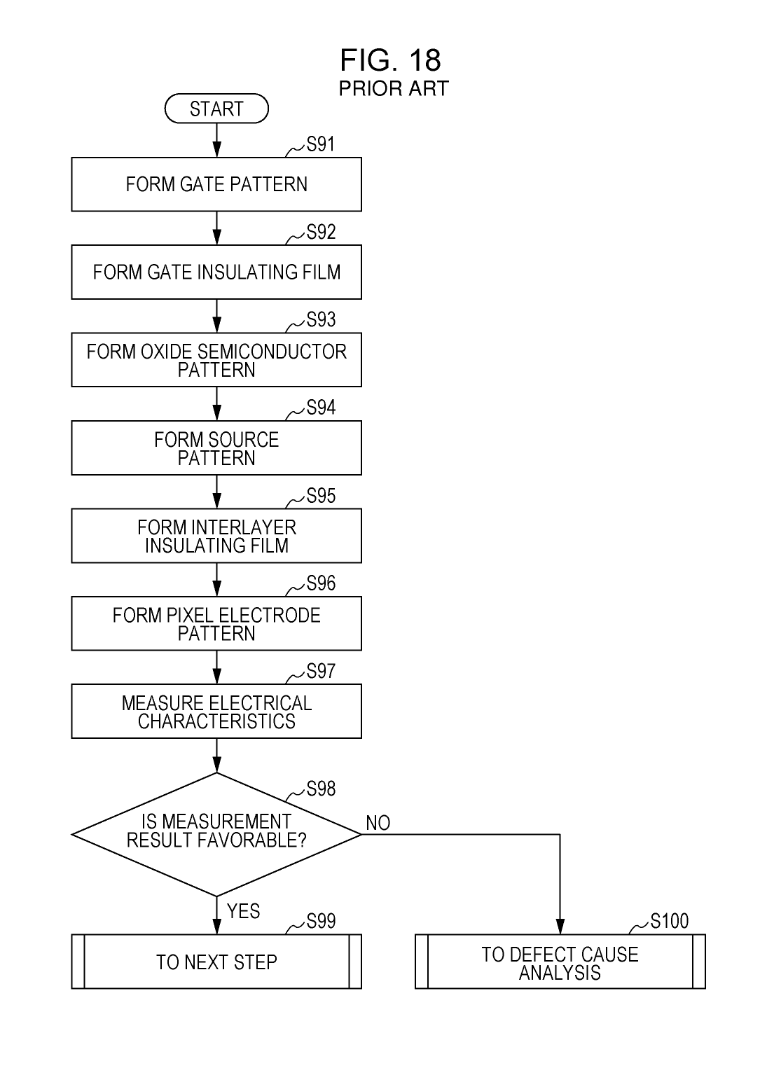

Description will be given below of a comparative example of the present embodiment before describing the effects of the vacuum chamber 1 of the present embodiment with reference to FIG. 18. Description will be given of a method of producing and evaluating a TFT using the techniques in the related art in the comparative example. Here, a film-forming apparatus and an analysis apparatus are provided separately in the techniques in the related art.

FIG. 18 is a flowchart which illustrates a flow of steps (Steps S91 to S100) for producing and evaluating a TFT in the comparative example. A TFT is produced in Steps S91 to S96 in the comparative example. In addition, the produced TFT is evaluated in Steps 97 and 98. The specific steps are as follows.

Firstly, a TFT gate pattern is formed (Step S91). Then, a gate insulating film is formed (Step S92) and an oxide semiconductor pattern is formed (Step S93). Subsequently, a source pattern is formed (Step S94), an interlayer insulating film is formed (Step S95), and a pixel electrode pattern is formed (Step S96).

Next, electrical characteristics of the produced TFT are measured (Step S97) and it is determined whether or not the measurement result is favorable (Step S98). In a case where the measurement result is favorable (YES in Step S98), the flow proceeds to the next step (Step S99). On the other hand, in a case where the measurement result is not favorable (defective) (NO in Step S98), the flow proceeds to defect cause analysis (Step S100).

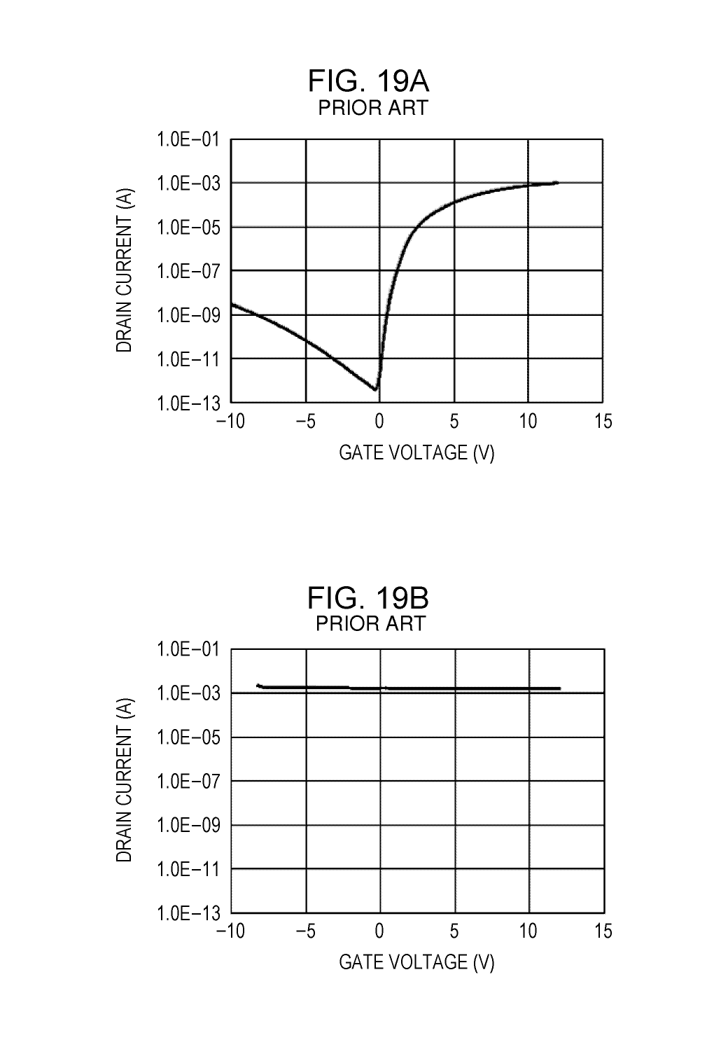

Here, FIGS. 19A and 19B are graphs which illustrate the measurement results (I-V characteristics) of the electrical characteristics of the TFT in Step S97 described above. FIG. 19A is a graph which illustrates electrical characteristics of a favorable TFT and FIG. 19B is a graph which illustrates electrical characteristics of a defective TFT.

In FIGS. 19A and 19B, the horizontal axis of the graph represents a gate voltage of the TFT and the vertical axis of the graph represents a drain current of the TFT. As shown in FIG. 19A, in a favorable TFT, the drain current starts to flow when the gate voltage exceeds a certain voltage and the drain current also increases along with the increase in the gate voltage. On the other hand, as shown in FIG. 19B, in a defective TFT, electrical characteristics are observed where the drain current continues to flow to a large extent even when the gate voltage changes.

As shown in FIG. 18, in the comparative example, the electrical characteristics are measured (Step S97) after producing the entire TFT (Steps S91 to S96). Accordingly, it is not possible to obtain information about the oxide semiconductor thin film until the entire TFT is produced.

Therefore, there is a problem in that it is not possible to quickly obtain the information about the oxide semiconductor thin film. For this reason, in the comparative example, it is not possible to quickly give feedback regarding the information about the oxide semiconductor thin film for reviewing the manufacturing conditions of the TFT.

In addition, in the comparative example, since the film-forming apparatus and the analysis apparatus are provided separately, the TFT has to be transferred from the film-forming apparatus to the analysis apparatus in order to evaluate the produced TFT. For this reason, the TFT has to be exposed to the atmosphere at least once.

Therefore, there is a problem in that it is not possible to obtain accurate information about the oxide semiconductor thin film due to the surface of the oxide semiconductor thin film being contaminated.

### Effects of Vacuum Chamber 1

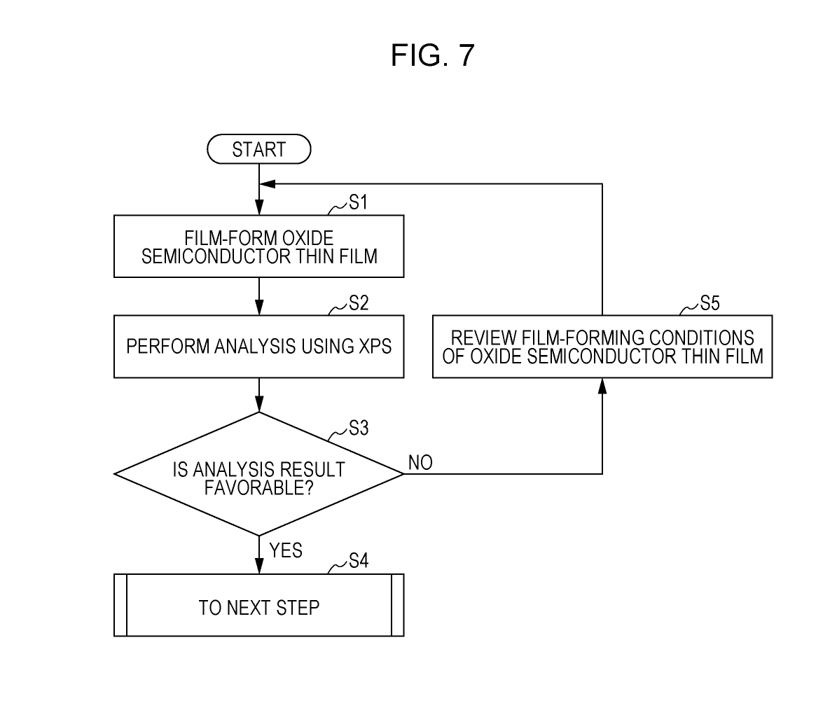

Description will be given below of the effects of the vacuum chamber 1 of the present embodiment with reference to FIG. 7. FIG. 7 is a flowchart which illustrates a flow of steps (Steps S1 to S5) for film-forming and analyzing (evaluating) an oxide semiconductor thin film in the vacuum chamber 1.

As shown in FIGS. 6A to 6D described above, in the present embodiment, firstly, the oxide semiconductor thin film is film-formed (Step S1). Then, analysis of the film-formed oxide semiconductor thin film is performed using XPS (Step S2) and it is determined whether or not the analysis result is favorable (Step S3).

In a case where the analysis result is favorable (YES in Step S3), the flow proceeds to the next step (Step S4). The next step may be, for example, a step of producing other portions of the TFT (an electrode, an insulating film, or the like).

On the other hand, in a case where the analysis result is not favorable (defective) (NO in Step S3), the film-forming conditions of the oxide semiconductor thin film are reviewed (Step S5). Then, returning to Step S1, an oxide semiconductor thin film is film-formed again using the reviewed film-forming conditions for the oxide semiconductor thin film.

According to the vacuum chamber 1 of the present embodiment, it is possible to obtain information about an oxide semiconductor thin film at the time of completing the film-forming of the oxide semiconductor thin film which is a stage prior to producing the entire TFT. Therefore, there is an effect that it is possible to quickly give feedback regarding the information about the oxide semiconductor thin film for reviewing the film-forming conditions of the oxide semiconductor thin film.

In addition, since analysis is performed using XPS in the stage prior to producing the entire TFT, it is possible to obtain accurate information about the oxide semiconductor thin film without being influenced by other portions of the TFT (an electrode, an insulating film, or the like).

In addition, as described above, the vacuum chamber 1 of the present embodiment is configured as a film-forming and analysis composite apparatus in which the analysis apparatus 1a and the film-forming apparatus 1b are combined by providing the valve 12.

Accordingly, it is possible to perform analysis using XPS without exposing the oxide semiconductor thin film to the atmosphere after film-forming the oxide semiconductor thin film. Therefore, it is possible to keep the surface of the oxide semiconductor thin film from being contaminated.

Since the result of analysis using XPS is easily affected by the state of a surface of a sample, it is possible to obtain accurate information about the oxide semiconductor thin film using XPS by keeping the surface of the oxide semiconductor thin film from being contaminated.

In this manner, according to the vacuum chamber 1, it is possible to obtain an advantage in that it is possible to quickly and accurately obtain the information about the oxide semiconductor thin film. Therefore, there is an effect that it is possible to favorably determine if a semiconductor element (for example, TFT) which is provided with an oxide semiconductor thin film is good or bad.

Here, the TFT is given as an example of a semiconductor element which is provided with an oxide semiconductor thin film in the present embodiment; however, the semiconductor element is not limited thereto. The semiconductor element may be, for example, an MOS field effect transistor (MOSFET) or the like.

### Embodiment 2

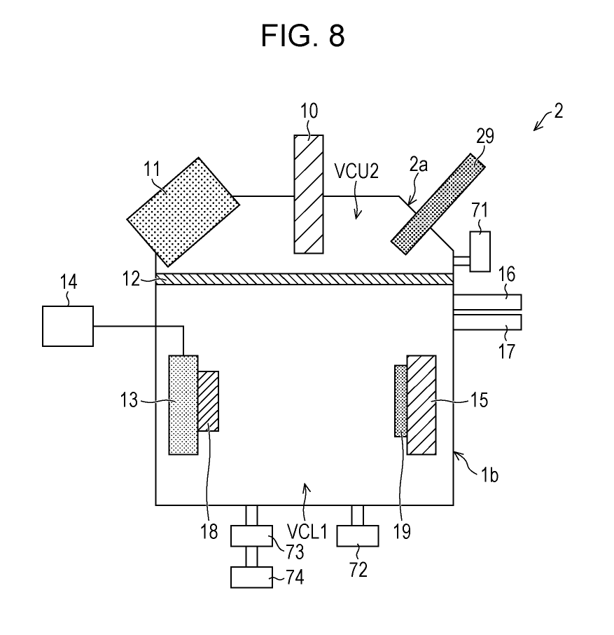

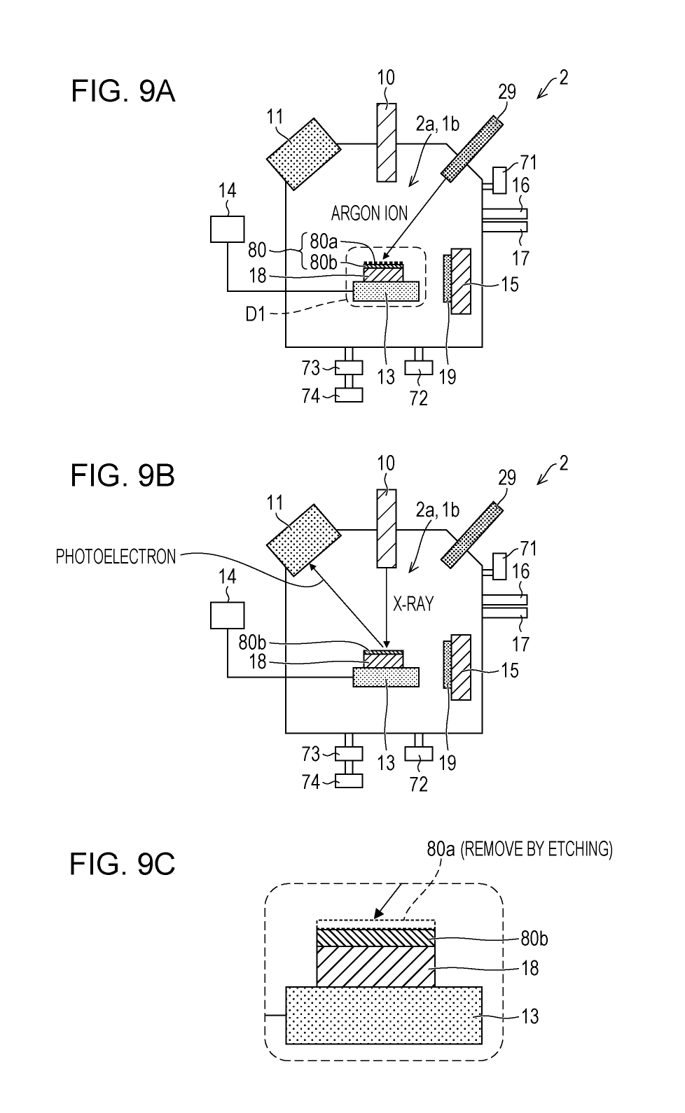

Description will be given of another embodiment of the disclosure based on FIG. 8 and FIGS. 9A to 9C. Here, for convenience of description, the same reference numerals are given to members which have the same functions as the members described in the previous embodiment and description thereof will be omitted.

### Configuration of Vacuum Chamber 2

FIG. 8 is a diagram which shows a configuration of a vacuum chamber 2 (a film-forming and analysis composite apparatus) of the present embodiment. The vacuum chamber 2 of the present embodiment has a configuration which is realized by replacing the analysis apparatus 1a of Embodiment 1 with an analysis apparatus 2a. Then, the analysis apparatus 2a of the present embodiment has a configuration which is realized by adding an argon ion gun 29 (an ion gun) to the analysis apparatus 1a of Embodiment 1.

The argon ion gun 29 irradiates an oxide semiconductor thin film with argon ions (etching ions). The oxide semiconductor thin film is etched by being irradiated with the argon ions.

Here, in the present embodiment, a configuration where argon is used as an ion gas (etching ions) which etches the oxide semiconductor thin film is given as an example; however, the etching ions are not limited to argon ions.

For example, an ion gas of noble gases other than argon such as xenon, krypton, neon, and helium may be used as etching ions.

Furthermore, gas cluster ions may be used as etching ions. Specific examples of the gas cluster ions include fullerene (C₆₀) ions or argon cluster (for example, Ar₅₀₀ to Ar₂₅₀₀) ions, or the like.

In addition, as shown in FIG. 8, it is possible to divide a space in the inside of the vacuum chamber 2 into two spaces of a first space VCU 2 (a second space) and the second space VCL 1 using the valve 12. The first space VCU 2 of the present embodiment is a space where the analysis apparatus 2a is provided.

Each Step from Film-Forming to Analysis of Oxide Semiconductor Thin Film in Vacuum Chamber 2

Next, description will be given of each step (a first step to a sixth step) of film-forming and analysis of the oxide semiconductor thin film 80 in the vacuum chamber 2 with reference to FIGS. 9A to 9C.

Here, since the first step to the fourth step of the present embodiment are the same steps as the first step to the fourth step in Embodiment 1, description thereof will be omitted. Description will be given below of the fifth step and the sixth step. Here, in the fifth step and the sixth step, the valve 12 is opened and communication is permitted between the first space VCU 2 and the second space VCL 1.

The fifth step is a step after analysis using XPS is completed with respect to the uppermost surface of the oxide semiconductor thin film 80 in the fourth step.

Here, a region in the vicinity of the uppermost surface of the oxide semiconductor thin film 80 is represented as a first region 80a. In addition, a region other than the first region 80a (that is, a region which is present at a position which is deeper than the vicinity of the uppermost surface) of the oxide semiconductor thin film 80 is represented as a second region 80b. Accordingly, in the fourth step, analysis is performed using XPS with respect to the surface of the first region 80a.

As shown in FIG. 9A, in the fifth step, the first region 80a is irradiated with argon ions from the argon ion gun 29. Due to this, as shown in FIG. 9C, the first region 80a is removed by etching and only the second region 80b remains. Accordingly, it is possible to expose the surface of the second region 80b as the uppermost surface of the oxide semiconductor thin film 80.

FIG. 9A is a diagram which shows a state where the first region 80a is irradiated with argon ions from the argon ion gun 29 in the fifth step. Here, in FIG. 9A, a region in the vicinity of the oxide semiconductor thin film 80 is shown as a region D1. In addition, FIG. 9C is an enlarged diagram of the region D1 in FIG. 9A.

Subsequently, as shown in FIG. 9B, the surface of the second region 80b is irradiated with X-rays from the X-ray source 10 in the sixth step. Then, photoelectrons which are released from the surface of the second region 80b are detected by the photoelectron detector 11.

FIG. 9B is a diagram which shows a state where the surface of the second region 80b is irradiated with X-rays from the X-ray source 10 and the photoelectrons which are released from the surface of the second region 80b are detected by the photoelectron detector 11 in the sixth step.

In this manner, the sixth step is the same as the fourth step described above apart from the point that the target of the analysis using XPS is the second region 80b. By analyzing the photoelectrons which are detected in the sixth step using XPS, it is possible to obtain information about the composition ratio, the bonding state, or the like of the oxide semiconductor thin film 80 in the vicinity of the second region 80b.

### Effects of Vacuum Chamber 2

According to the vacuum chamber 2 of the present embodiment, it is possible to remove the first region 80a where the analysis using XPS is performed in the previous step (the fourth step) and leave the second region 80b which is present at a position which is deeper than the first region 80a (that is, to expose the surface) in the fifth step. Then, it is possible to perform the analysis using XPS with respect to the second region 80b in the sixth step.

Therefore, by performing the analysis using XPS with respect to the oxide semiconductor thin film 80 by repeating the fifth step and the sixth step, there is an effect that it is possible to obtain information about the composition ratio, the bonding state, or the like in the depth direction of the oxide semiconductor thin film 80.

### Embodiment 3

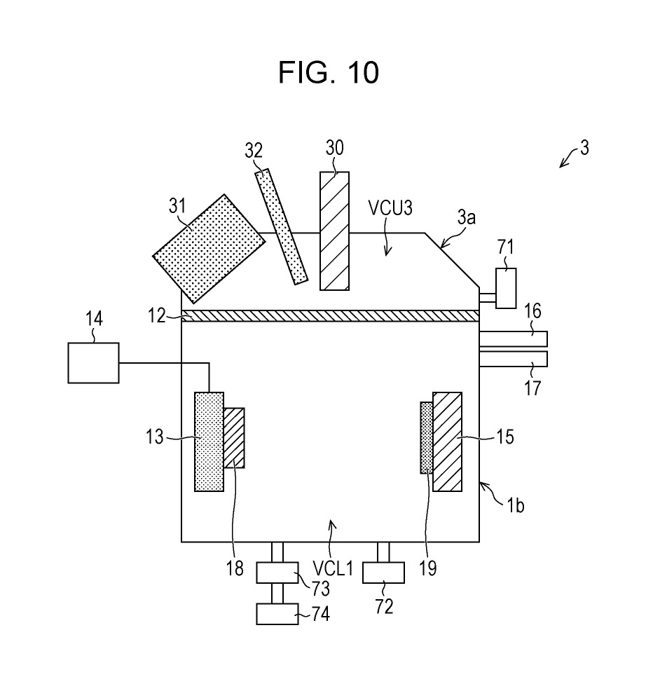

Description will be given of another embodiment of the disclosure based on FIG. 10 to FIG. 15. Here, for convenience of description, the same reference numerals are given to members which have the same functions as the members described in the previous embodiments and description thereof will be omitted.

### Configuration of Vacuum Chamber 3

FIG. 10 is a diagram which shows a configuration of a vacuum chamber 3 (a film-forming and analysis composite apparatus) of the present embodiment. The vacuum chamber 3 of the present embodiment has a configuration which is realized by replacing the analysis apparatus 1a of Embodiment 1 with an analysis apparatus 3a.

Then, the analysis apparatus 3a of the present embodiment has a configuration which is realized by (i) replacing the X-ray source 10 with an electron gun 30 (an inspection radiation source) and replacing the photoelectron detector 11 with an Auger electron detector 31 (an electron detector) and (ii) adding a secondary electron detector 32 in the analysis apparatus 1a of Embodiment 1.

The vacuum chamber 3 is configured so as to be able to film-form an oxide semiconductor thin film and perform spectroscopic analysis using Auger Electron Spectroscopy (AES) with respect to the oxide semiconductor thin film.

Accordingly, the vacuum chamber 3 of the present embodiment is different from the vacuum chambers of Embodiments 1 and 2 described above (vacuum chambers which are configured such that spectroscopic analysis using XPS is possible) in the point of being configured such that spectroscopic analysis using AES is possible.

In addition, as shown in FIG. 10, it is possible to divide a space in the inside of the vacuum chamber 3 into two spaces of a first space VCU 3 (a second space) and the second space VCL 1 using the valve 12. The first space VCU 3 of the present embodiment is a space where the analysis apparatus 3a is provided.

The electron gun 30 irradiates an oxide semiconductor thin film with an electron beam as inspection radiation. Here, the electrons which are included in the electron beam are also referred to as primary electrons.

Due to the oxide semiconductor thin film being irradiated with the electron beam (primary electrons), Auger electrons are released from the surface of the oxide semiconductor thin film. In addition, due to the oxide semiconductor thin film being irradiated with the electron beam, secondary electrons are released from the surface of the oxide semiconductor thin film in addition to the Auger electrons.

The Auger electron detector 31 detects Auger electrons which are released from the surface of the oxide semiconductor thin film. In addition, the secondary electron detector 32 detects secondary electrons which are released from the surface of the oxide semiconductor thin film.

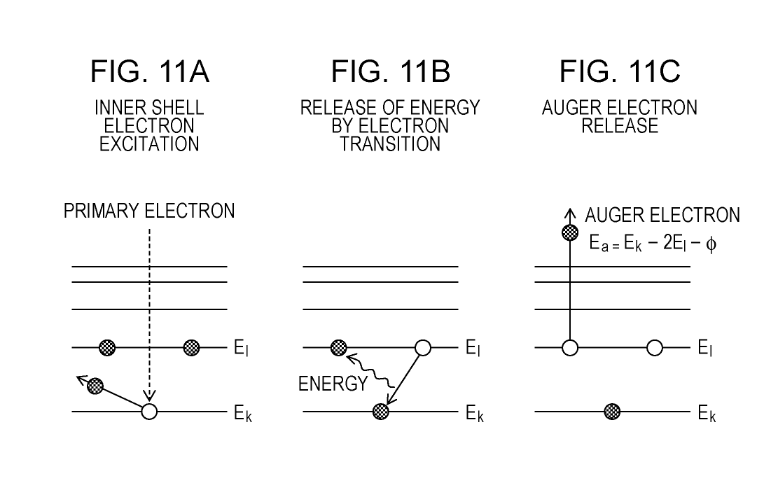

The secondary electrons which are to be detected by the secondary electron detector 32 are released into a vacuum due to electrons in the solid body being excited by inelastic scattering of the primary electrons, and the energy thereof is mostly 50 eV or less. Secondary electrons are also detected by the Auger electron detector 31; however, since the signal strength of the secondary electrons is weaker than the signal strength of the Auger electrons in an energy band (mostly, 50 eV to 2300 eV) where the Auger electrons are generated, the signal of the secondary electrons is the background of the spectrum. Here, description will be given below of the Auger electron releasing process (refer to FIGS. 11A to 11C).

### AES Principles

As described above, spectroscopic analysis using AES is performed with respect to an oxide semiconductor thin film as a sample in the vacuum chamber 3. Description will be briefly given below of the principles of AES with reference to FIG. 11A to FIG. 13B.

FIGS. 11A to 11C are diagrams which illustrate energy bands of electrons in the AES. Description will be given below of a case where Auger electrons are released along with the transition of electrons from an inner shell (k shell) to an outer shell (l shell) with reference to FIGS. 11A to 11C.

Here, binding energy of an inner shell electron is represented as Eₖ, binding energy of an outer shell electron is represented as Eₗ, a work function of the sample is represented as #, and the kinetic energy of the Auger electrons is represented as Eₐ.

Firstly, inner shell electrons are excited due to a sample being irradiated with an electron beam (primary electrons) from the electron gun 30. As a result, the inner shell electrons are released from the inner shell to the outside. FIG. 11A is a diagram which shows a state where the inner shell electrons are released.

Subsequently, when the inner shell is empty, the outer shell electrons enter the orbit of the empty inner shell. Then, when the outer shell electrons enter the inner shell from the outer shell, excess energy (that is, Eₗ−Eₖ) is released. The excess energy is given to other outer shell electrons which remain in the outer shell. FIG. 11B is a diagram which shows a state where the excess energy is given to the other outer shell electrons which remain in the outer shell.

Subsequently, by the excess energy being given to the other outer shell electrons which remain in the outer shell, the outer shell electrons are released from the outer shell to the outside of the sample as Auger electrons which have kinetic energy Eₐ. Then, the released Auger electrons are detected by the Auger electron detector 31. Here, the kinetic energy Eₐ of the Auger electrons is represented as Eₐ=Eₖ−2Eₗ−φ.

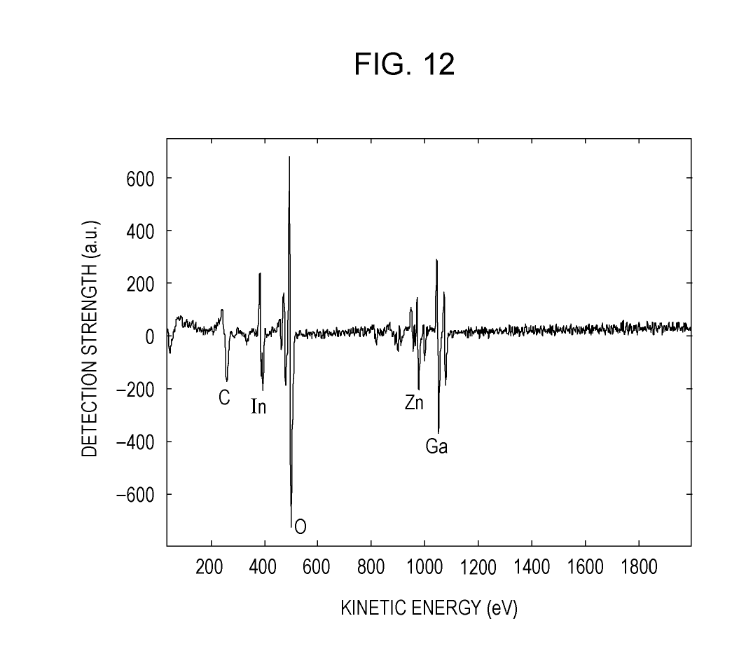

The spectrum (AES spectrum) of an Auger electron is analyzed using AES. FIG. 12 is a graph which shows an example of the AES spectrum. The horizontal axis of the graph represents the kinetic energy (unit: eV) of Auger electrons and the vertical axis of the graph represents the detection strength (unit: a.u. (arbitrary unit)) of Auger electrons.

Since the peak position and the peak shape of the AES spectrum are unique for each element, it is possible to specify the elements in a sample by referring to the peak positions and the peak shapes. In addition, by referring to the peak position and the peak shape of the AES spectrum, it is also possible to analyze the chemical bonding state (an oxidation state or the like) of each of the elements.

In addition, by referring to the peak strength (amplitude) of the AES spectrum, it is possible to calculate the element concentration in the sample. Here, by calculating the element concentration, it is possible to perform element analysis (semi-quantitative).

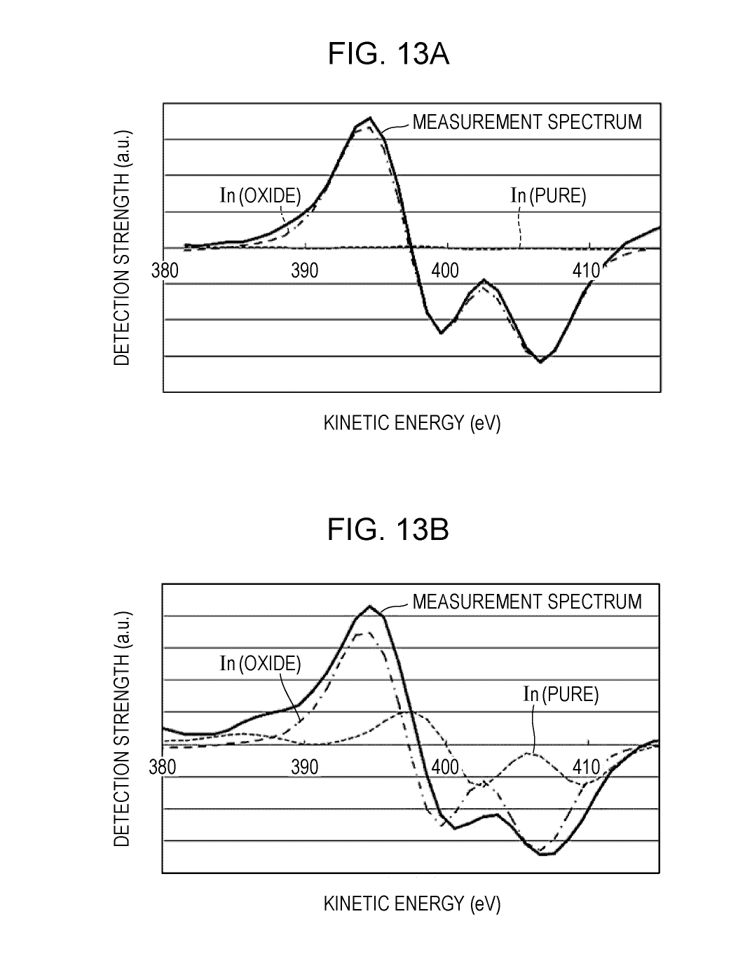

FIGS. 13A and 13B are graphs which show an example of the AES spectrum of In at a normal time and at an abnormal time. In the same manner as FIG. 12, the horizontal axis of the graph also represents the kinetic energy of the Auger electrons and the vertical axis of the graph also represents the detection strength of the Auger electrons in FIGS. 13A and 13B.

As shown in FIGS. 13A and 13B, the peak shapes of the AES spectrum are different at a normal time and at an abnormal time. In this manner, by referring to the peak position and the peak shape, it is also possible to specify which of the elements an abnormality is generated in.

Here, an energy dispersive X-ray spectrometer (EDX) is known as another inspection method for obtaining information in the vicinity of a surface of a sample. It is possible to obtain information in a range from the surface of the sample to a depth of approximately 1 μm using the EDX.

On the other hand, the Auger electrons which are detected in the AES are electrons which are present in a range from the surface of the sample to a depth of approximately a few nm. For this reason, according to the AES, it is possible to obtain information only in the vicinity of the uppermost surface of the sample.

In addition, since AES is an analysis method which is excellent in spatial resolution, the AES is favorable for element analysis or bonding state analysis with respect to minute regions.

Each Step from Film-Forming to Analysis of Oxide Semiconductor Thin Film in Vacuum Chamber 3

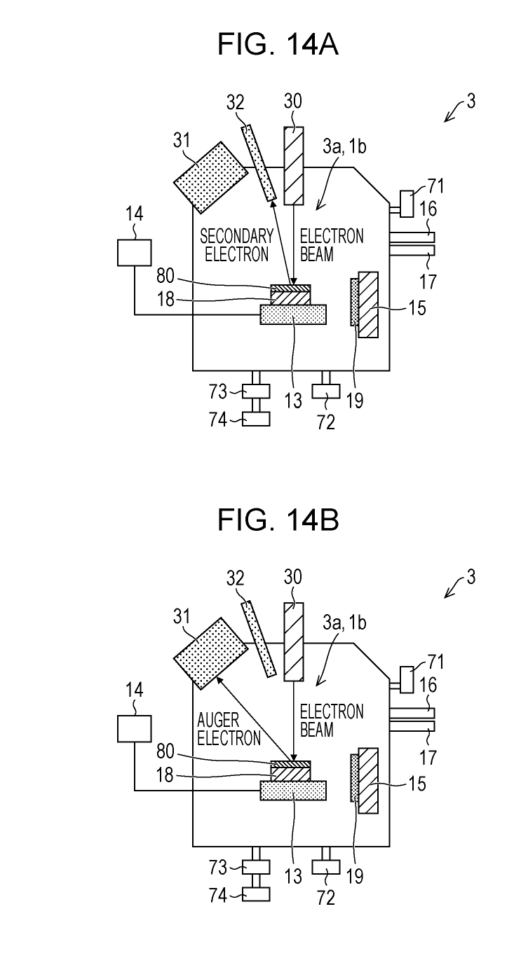

Next, description will be given of each step (a first step to a fifth step) of film-forming and analysis of the oxide semiconductor thin film 80 in the vacuum chamber 3 with reference to FIGS. 14A and 14B.

Here, since the first step to the third step of the present embodiment are the same steps as the first step to the third step in Embodiment 1, description thereof will be omitted. Description will be given below of the fourth step and the fifth step. Here, in the fourth step and the fifth step, the valve 12 is opened and communication is permitted between the first space VCU 3 and the second space VCL 1.

The fourth step of the present embodiment is a step after the third step is completed. In the fourth step, firstly, the position of the substrate holder 13 is changed by the position adjusting mechanism 14 and the substrate 18 is arranged so as to oppose the electron gun 30.

Then, the surface of the oxide semiconductor thin film 80 which is film-formed on the surface of the substrate 18 is irradiated with an electron beam from the electron gun 30. Due to this, secondary electrons are released from the surface of the oxide semiconductor thin film 80. Next, the secondary electrons which are released from the surface of the oxide semiconductor thin film 80 are detected by the secondary electron detector 32.

FIG. 14A is a diagram which shows a state where the surface of the oxide semiconductor thin film 80 is irradiated with an electron beam from the electron gun 30 and the secondary electrons which are released from the surface of the oxide semiconductor thin film 80 are detected by the secondary electron detector 32 in the fourth step.

In this manner, by detecting the secondary electrons, it is possible to obtain a secondary electron image of the surface of the oxide semiconductor thin film 80. Due to this, it is possible to evaluate the shape of the surface of the oxide semiconductor thin film 80.

Subsequently, in the fifth step of the present embodiment, analysis using AES is performed with respect to the surface of the oxide semiconductor thin film 80. In the fifth step, firstly, by referring to the secondary electron image which is obtained in the fourth step, the region of the surface of the oxide semiconductor thin film 80 which is the AES analysis target is determined.

In detail, by referring to the secondary electron image, a region which is flat and does not include foreign matter is selected in the surface of the oxide semiconductor thin film 80. Then, the region is determined as the AES analysis target.

This is because it is difficult to acquire a normal spectrum (i) in a case where a portion with a different level such as a wiring pattern is included in the region which is the analysis target or (ii) in a case where foreign matter is included in the region which is the analysis target.

Accordingly, by setting a region which is flat and does not include foreign matter as the analysis target, it is possible to more reliably acquire a normal spectrum using AES.

Subsequently, the region of the surface of the oxide semiconductor thin film 80 which is determined as the analysis target is irradiated with an electron beam from the electron gun 30. Due to this, Auger electrons are released from the region of the surface. Next, Auger electrons which are released from the region of the surface are detected by the Auger electron detector 31.

Then, by analyzing the AES spectrum of the Auger electrons which are detected in the fifth step, it is possible to obtain information such as the composition rate, bonding state, or the like of the oxide semiconductor thin film 80.

### Effects of Vacuum Chamber 3

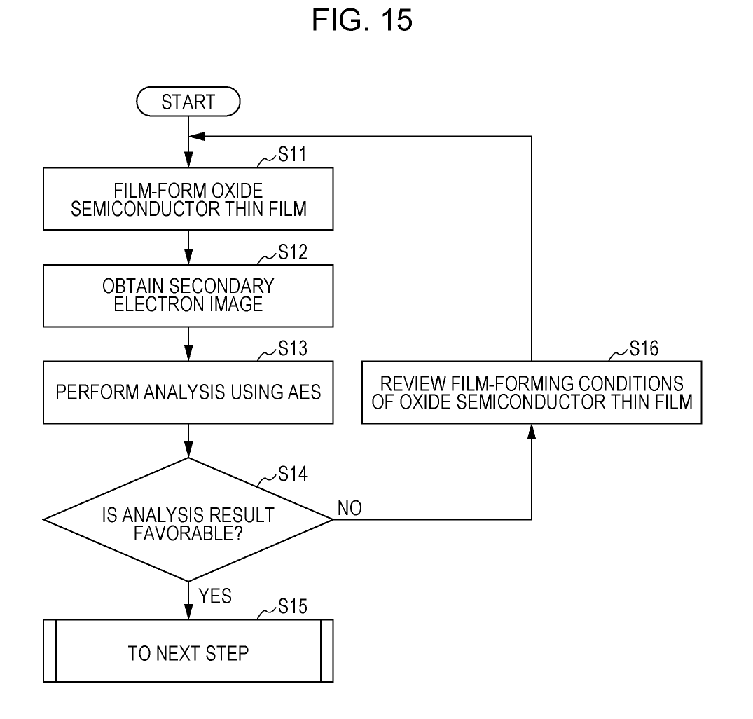

Description will be given below of the effects of the vacuum chamber 3 of the present embodiment with reference to FIG. 15. FIG. 15 is a flowchart which illustrates a flow of steps (Steps S11 to S16) for film-forming and analysis of an oxide semiconductor thin film in the vacuum chamber 3.

Here, since each of Steps S11 and S14 to S16 in FIG. 15 are the same steps as Steps S1 and S3 to S5 in FIG. 7 described above, description thereof will be omitted. The steps shown in FIG. 15 are steps which are realized by replacing Step S2 in the steps in FIG. 7 with Steps S12 and S13.

As shown in FIG. 14A, in the present embodiment, secondary electrons which are released from a surface of a film-formed oxide semiconductor thin film are detected and a secondary electron image of the surface of the oxide semiconductor thin film is obtained (Step S12). Then, by referring to the secondary electron image, a region of the surface of the oxide semiconductor thin film which is the AES analysis target is determined.

Subsequently, as shown in FIG. 14B, Auger electrons which are released from the surface of the oxide semiconductor thin film 80 which is determined as the analysis target are detected and analysis using AES is performed (Step S13).

Accordingly, in the same manner as the vacuum chamber 1 of Embodiment 1, there is also an effect that it is possible to more quickly and accurately obtain information about an oxide semiconductor thin film than in the related art with the vacuum chamber 3 of the present embodiment.

In addition, according to the vacuum chamber 3 of the present embodiment, it is possible to perform analysis using AES with respect to an oxide semiconductor thin film. Therefore, the vacuum chamber 3 is particularly favorable in a case of performing element analysis or bonding state analysis with respect to minute regions.

Here, in the same manner as the XPS of Embodiments 1 and 2, AES is also an analysis method which is easily affected by the state of a surface of a sample. For this reason, by keeping the surface of the oxide semiconductor thin film from being contaminated by the vacuum chamber 3, it is possible to obtain accurate information about the oxide semiconductor thin film using AES.

In addition, by providing the secondary electron detector 32 in the vacuum chamber 3, it is possible to obtain a secondary electron image of the surface of the oxide semiconductor thin film 80. Due to this, in a case where an abnormality is generated in the shape of the surface of the oxide semiconductor thin film 80, it is possible to obtain an advantage that it is possible to quickly discover the abnormality.

### Modified Example

Here, in Embodiment 3 described above, a configuration where the electron gun 30, the Auger electron detector 31, and the secondary electron detector 32 are provided in the analysis apparatus 3a is given as an example.

However, in order to perform analysis using AES with respect to an oxide semiconductor thin film, it is sufficient if only the electron gun 30 and the Auger electron detector 31 are provided in the analysis apparatus 3a. Accordingly, the secondary electron detector 32 is not an indispensable constituent component for the analysis apparatus 3a.

### Embodiment 4

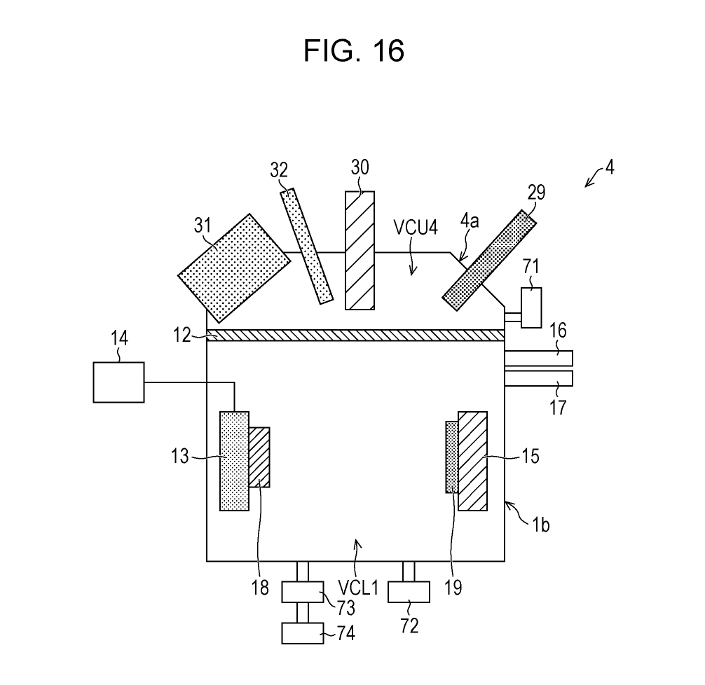

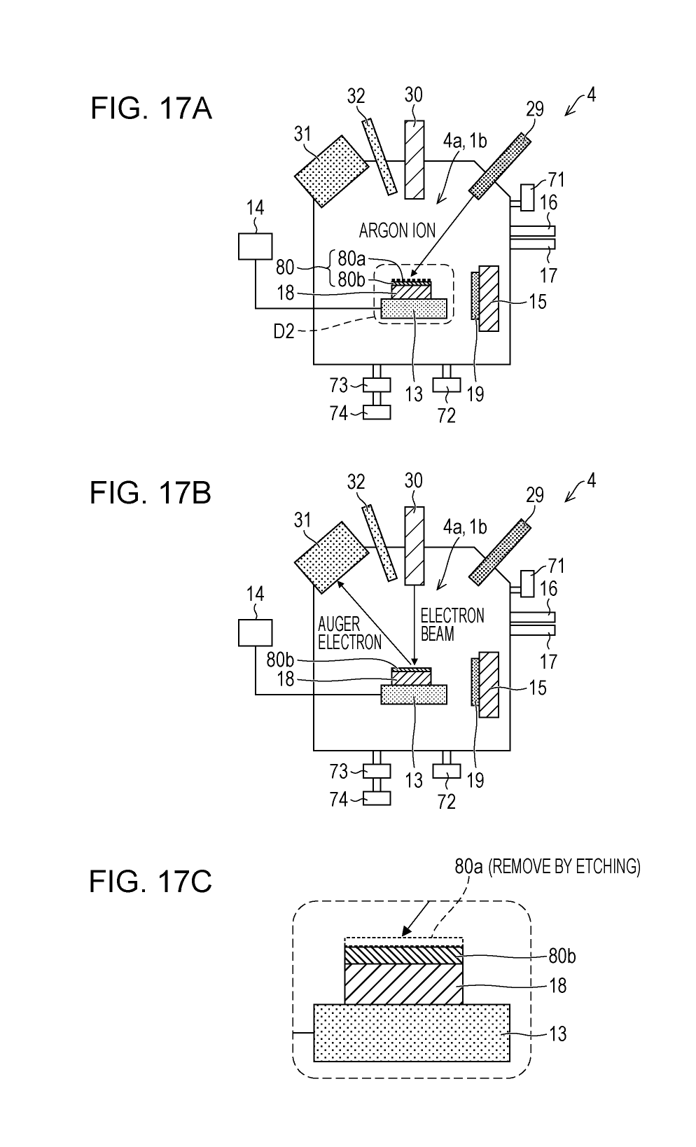

Description will be given of another embodiment of the disclosure based on FIG. 16 and FIGS. 17A to 17C. Here, for convenience of description, the same reference numerals are given to members which have the same functions as the members described in the previous embodiments and description thereof will be omitted.

### Configuration of Vacuum Chamber 4

FIG. 16 is a diagram which shows a configuration of a vacuum chamber 4 (a film-forming and analysis composite apparatus) of the present embodiment. The vacuum chamber 4 of the present embodiment has a configuration which is realized by replacing the analysis apparatus 3a of Embodiment 3 with an analysis apparatus 4a. Then, the analysis apparatus 4a of the present embodiment has a configuration which is realized by adding the argon ion gun 29 of Embodiment 2 to the analysis apparatus 3a of Embodiment 3.

In addition, as shown in FIG. 16, it is possible to divide a space in the inside of the vacuum chamber 4 into two spaces of a first space VCU 4 (a second space) and the second space VCL 1 using the valve 12. The first space VCU 4 of the present embodiment is a space where the analysis apparatus 4a is provided.

Each Step from Film-Forming to Analysis of Oxide Semiconductor Thin Film in Vacuum Chamber 4

Next, description will be given of each step (a first step to a seventh step) of film-forming and analysis of the oxide semiconductor thin film 80 in the vacuum chamber 4 with reference to FIGS. 17A to 17C.

Here, since the first step to the fifth step of the present embodiment are the same steps as the first step to the fifth step in Embodiment 3, description thereof will be omitted. Description will be given below of the sixth step and the seventh step.

Here, in the sixth step and the seventh step, the valve 12 is opened and communication is permitted between the first space VCU 4 and the second space VCL 1.

In the same manner as Embodiment 2, a region in the vicinity of the uppermost surface of the oxide semiconductor thin film 80 is also represented as the first region 80a in the present embodiment. In addition, a region other than the first region 80a of the oxide semiconductor thin film 80 is represented as the second region 80b.

The sixth step of the present embodiment is a step after analysis using AES is completed with respect to the surface of the first region 80a of the oxide semiconductor thin film 80 in the fifth step. The sixth step of the present embodiment is the same as the fifth step in Embodiment 2.

That is, as shown in FIG. 17A, the first region 80a is irradiated with argon ions from the argon ion gun 29 in the sixth step. Due to this, as shown in FIG. 17C, the first region 80a is removed by etching and only the second region 80b remains.

FIG. 17A is a diagram which shows a state where the first region 80a is irradiated with argon ions from the argon ion gun 29 in the sixth step. Here, in FIG. 17A, a region in the vicinity of the oxide semiconductor thin film 80 is shown as a region D2. In addition, FIG. 17C is an enlarged diagram of the region D2 in FIG. 17A.

Then, the seventh step of the present embodiment is almost the same as the sixth step in Embodiment 2. As shown in FIG. 17B, the surface of the second region 80b is irradiated with an electron beam from the electron gun 30 in the seventh step. Then, Auger electrons which are released from the surface of the second region 80b are detected by the Auger electron detector 31.

FIG. 17B is a diagram which shows a state where the surface of the second region 80b is irradiated with an electron beam from the electron gun 30 and Auger electrons which are released from the surface of the second region 80b are detected by the Auger electron detector 31 in the seventh step.

By analyzing the Auger electrons which are detected in the seventh step using AES, it is possible to obtain information about the composition ratio, the bonding state, or the like of the oxide semiconductor thin film 80 in the vicinity of the second region 80b.

In this manner, the seventh step of the present embodiment is the same as the sixth step in Embodiment 2 apart from the point that the analysis method which is used for analyzing the second region 80b is AES.

### Effects of Vacuum Chamber 4

According to the vacuum chamber 4 of the present embodiment, by repeating the sixth step and the seventh step, in the same manner as the vacuum chamber 2 of Embodiment 2, there is an effect that it is possible to obtain information about the composition ratio, the bonding state, or the like in the depth direction of the oxide semiconductor thin film 80.

In addition, according to the vacuum chamber 4 of the present embodiment, it is possible to perform analysis using AES with respect to an oxide semiconductor thin film. Therefore, the vacuum chamber 4 is particularly favorable in a case of performing element analysis or bonding state analysis with respect to the depth direction of minute regions.

### Overview

The film-forming and analysis composite apparatus (the vacuum chamber 1) according to Embodiment 1 of the disclosure has a function as a vacuum chamber which can make an inner space thereof a vacuum, and is provided with a film-forming apparatus (1b) which film-forms a sample (the oxide semiconductor thin film 80) by sputtering, an analysis apparatus (1a) which performs spectroscopic analysis with respect to a surface of the sample which is film-formed, and an interrupting member (the valve 12) which splits the inner space into a first space (VCU 1) where the analysis apparatus is arranged and a second space (VCL 1) where the film-forming apparatus is arranged and permits communication between the split first space and second space.

According to the configuration described above, by performing sputtering by the film-forming apparatus in the second space after splitting the space into the first space and the second space using the interrupting member, it is possible to film-form a sample in the inside of the second space (refer to FIGS. 6A and 6B).

Subsequently, by permitting communication between the first space and the second space using the interrupting member after producing a vacuum in the first space and the second space, it is possible to keep sputtering gas which is used for the sputtering from flowing from the first space VCU 1 into the second space VCL 1 (refer to FIG. 6C). Due to this, it is possible to keep the surface of the film-formed sample from being contaminated.

Subsequently, by performing spectroscopic analysis (for example, analysis using XPS or AES) with respect to the surface of the film-formed sample, it is possible to obtain information about the sample (for example, information about the composition ratio, the bonding state, or the like on the surface of the sample) (refer to FIG. 6D).

In this manner, according to the film-forming and analysis composite apparatus according to an aspect of the disclosure, it is possible to perform spectroscopic analysis with respect to the surface of the sample while maintaining a state where the surface of the sample is not contaminated after film-forming the sample. Therefore, it is possible to obtain accurate information about the surface of the sample.

In addition, according to the film-forming and analysis composite apparatus according to an aspect of the disclosure, since a film-forming apparatus and an analysis apparatus are combined, unlike the related art, the sample which is film-formed by the film-forming apparatus has not to be transferred to the analysis apparatus. Therefore, it is possible to quickly obtain information about the sample.

That is, according to the film-forming and analysis composite apparatus according to an aspect of the disclosure, there is an effect that it is possible to quickly and accurately obtain information about the sample.

In addition, in the film-forming and analysis composite apparatus according to Embodiment 2 of the disclosure, it is preferable that the film-forming apparatus in Embodiment 1 described above is further provided with a substrate holder (13) which holds a substrate (18) which is a target where the sample is film-formed, and a position adjusting mechanism (14) which changes the position of the substrate holder.

According to the configuration described above, there is an effect that it is possible to arrange the surface of the sample at a position where spectroscopic analysis by the analysis apparatus is favorably performed (for example, a position which opposes an inspection radiation source) using the position adjusting mechanism.

In addition, in the film-forming and analysis composite apparatus according to Embodiment 3 of the disclosure, it is preferable that the position adjusting mechanism in Embodiment 2 described above is a servo mechanism for which rotational motion and motion in a horizontal direction are possible.

According to the configuration described above, there is an effect that it is possible to realize the position adjusting mechanism according to an aspect of the disclosure using a servo mechanism (for example, a servo actuator).

In addition, in the film-forming and analysis composite apparatus according to Embodiment 4 of the disclosure, it is preferable that the interrupting member in any one of Embodiments 1 to 3 described above is a gate valve.

According to the configuration described above, there is an effect that it is possible to realize the interrupting member according to an aspect of the disclosure using a gate valve.

In addition, in the film-forming and analysis composite apparatus according to Embodiment 5 of the disclosure, it is preferable that the interrupting member in any one of Embodiments 1 to 4 described above is provided with an O ring (94) which seals the split first space and the second space described above.

According to the configuration described above, there is an effect that it is possible to more reliably split the first space and the second space.

In addition, in the film-forming and analysis composite apparatus according to Embodiment 6 of the disclosure, it is preferable that the analysis apparatus in any one of Embodiments 1 to 5 described above is provided with an inspection radiation sources (the X-ray source 10 and the electron gun 30) which irradiates the surface with inspection radiation, and an electron detector (the photoelectron detector 11 and the Auger electron detector 31) which detects electrons which are released from the surface due to the irradiation of the inspection radiation.

According to the configuration described above, there is an effect that it is possible to realize an analysis apparatus which is able to perform spectroscopic analysis with respect to a surface of a sample.

In addition, in the film-forming and analysis composite apparatus according to Embodiment 7 of the disclosure, it is preferable that the inspection radiation source in Embodiment 6 described above is an X-ray source (10) which irradiates X-rays as the inspection radiation, and the electron detector is a photoelectron detector (11) which detects photoelectrons which are released from the surface due to the irradiation of the X-rays.

According to the configuration described above, there is an effect that it is possible to realize an analysis apparatus which is able to perform analysis using XPS with respect to a surface of a sample.

In addition, in the film-forming and analysis composite apparatus according to Embodiment 8 of the disclosure, it is preferable that the inspection radiation source in Embodiment 6 described above is an electron gun (30) which irradiates an electron beam as the inspection radiation, and the electron detector described above is an Auger electron detector (31) which detects Auger electrons which are released from the surface due to the irradiation of the electron beam.

According to the configuration described above, there is an effect that it is possible to realize an analysis apparatus which is able to perform analysis using AES with respect to a surface of a sample.

In addition, in the film-forming and analysis composite apparatus according to Embodiment 9 of the disclosure, it is preferable that the analysis apparatus in Embodiment 8 described above is further provided with a secondary electron detector (32) which detects secondary electrons which are released from the surface due to the irradiation of the electron beam.

According to the configuration described above, by detecting secondary electrons, it is possible to obtain a secondary electron image of a surface of a sample. Therefore, there is an effect that it is possible to determine a region (for example, a flat region) which is favorable for AES as the analysis target of the surface of the sample by referring to the secondary electron image.

In addition, in the film-forming and analysis composite apparatus according to Embodiment 10 of the disclosure, it is preferable that the analysis apparatus in any one of Embodiments 1 to 9 described above is further provided with an ion gun (the argon ion gun 29) which irradiates ions which etch the surface.

According to the configuration described above, it is possible to remove a surface of a sample by etching using ions and to expose a region which is present at a position which is deeper than the removed surface as a new surface of the sample. Accordingly, it is possible to perform spectroscopic analysis with respect to the surface of the sample which is newly exposed.

Therefore, there is an effect that it is possible to obtain information in the depth direction of the sample by repeatedly performing etching and spectroscopic analysis with respect to the surface of the sample.

In addition, in the film-forming and analysis composite apparatus according to Embodiment 11 of the disclosure, it is preferable that the sample in any one of Embodiments 1 to 10 described above is an oxide semiconductor thin film.

According to the configuration described above, it is possible to perform spectroscopic analysis of an oxide semiconductor thin film using the film-forming and analysis composite apparatus according to an aspect of the disclosure. Therefore, there is an effect that it is possible to favorably determine if a semiconductor element (for example, TFT) which is provided with an oxide semiconductor thin film is good or bad.

In addition, it is preferable that a method for controlling the film-forming and analysis composite apparatus according to Embodiment 12 of the disclosure is a method for controlling the film-forming and analysis composite apparatus according to any one of Embodiments 1 to 11 described above and includes splitting the first space and the second space before film-forming the sample by sputtering, film-forming the sample by sputtering in the second space which is formed by the splitting, producing a vacuum in the second space after the film-forming, permitting communication between the first space and the second space after the producing of the vacuum, and performing spectroscopic analysis with respect to the surface of the sample which is film-formed in the space for which communication is permitted by the permitting of the communication.

According to the configuration described above, by performing each of the processes of the splitting, the producing a vacuum, and the permitting communication, it is possible to keep sputtering gas which is used for sputtering in the film-forming from flowing from the second space into the first space.

Therefore, since it is possible to keep the surface of the sample which is the analysis target from being contaminated, there is an effect that it is possible to favorably perform spectroscopic analysis in a space for which communication is permitted in the analyzing.

In addition, a vacuum chamber (1) according to Embodiment 13 of the disclosure is a vacuum chamber which can make an inner space thereof a vacuum, and is provided with an interrupting member which splits the inner space into a first space (the second space VCL 1) where a film-forming apparatus which film-forms a sample by sputtering is arranged and a second space (the first space VCU 1) where an analysis apparatus which performs spectroscopic analysis with respect to the surface of the sample which is film-formed is arranged, and permits communication between the split first space and second space.

According to the configuration described above, it is possible to realize a vacuum chamber which is able to split and permit communication between a first space where a film-forming apparatus is arranged and a second space where an analysis apparatus is arranged. Therefore, there is an effect that it is possible to realize a vacuum chamber which is able to provide a film-forming and analysis composite apparatus which is able to quickly and accurately obtain information about a sample.

### Supplementary Information

The disclosure is not limited to each of the embodiments described above and various types of changes are possible within the range shown in the Claims and embodiments which are obtained by appropriately combining technical means respectively disclosed in different embodiments are also included in the technical range of the disclosure. Furthermore, by combining the technical means which are respectively disclosed in each of the embodiments, it is possible to form new technical features.

Here, it is also possible to express the disclosure as below.

That is, a film-forming and analysis composite apparatus according to an aspect of the disclosure is provided with an X-ray source, a photoelectron detector, a substrate holder, a sputtering electrode, and a sputtering target formed of an oxide semiconductor in a vacuum chamber and is provided with a valve between a chamber where the X-ray source and the photoelectron detector are installed and a chamber where the substrate holder and the sputtering target are installed, and it is possible to consistently carry out analysis of the composition ratio or the bonding state of an oxide semiconductor thin film which is formed from the forming of the oxide semiconductor thin film using an X-ray photoelectron spectroscopic analysis method without exposing a sample to the atmosphere.

In addition, a film-forming and analysis composite apparatus according to an aspect of the disclosure is the above film-forming and analysis composite apparatus, further provided with an argon ion gun in the same chamber as a chamber where an X-ray source and a photoelectron detector are installed and it is possible to consistently obtain information regarding a distribution of a composition or a bonding state in a depth direction without exposing a sample to the atmosphere from the forming of the oxide semiconductor thin film by repeating etching using argon ions and photoelectron spectroscopic analysis.

In addition, a film-forming and analysis composite apparatus according to an aspect of the disclosure is provided with an electronic gun, a secondary electron detector, an Auger electron detector, a substrate holder, a sputtering electrode and a sputtering target formed of an oxide semiconductor in a vacuum chamber and is provided with a valve between a chamber where the electronic gun, the secondary electron detector, and the Auger electron detector are installed and a chamber where the substrate holder and the sputtering target are installed, and it is possible to consistently carry out analysis of a composition ratio or a bonding state of an oxide semiconductor thin film which is formed from the forming of the oxide semiconductor thin film using an Auger electron spectroscopic analysis method without exposing a sample to the atmosphere.

In addition, a film-forming and analysis composite apparatus according to an aspect of the disclosure is the above film-forming and analysis composite apparatus, further provided with an argon ion gun in the same chamber as a chamber where an electron gun, a secondary electron detector, and an Auger electron detector are installed, and it is possible to consistently obtain information regarding the distribution of a composition or a bonding state in a depth direction without exposing a sample to the atmosphere from the forming of the oxide semiconductor thin film by repeating etching using argon ions and photoelectron spectroscopic analysis.

It is possible to use the disclosure for a film-forming and analysis composite apparatus in which a film-forming apparatus and an analysis apparatus are combined.

The present disclosure contains subject matter related to that disclosed in Japanese Priority Patent Application JP 2014-170947 filed in the Japan Patent Office on Aug. 25, 2014, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A film-forming and analysis composite apparatus having a function as a vacuum chamber which can make an inner space thereof a vacuum, the apparatus comprising:
a film-forming apparatus which film-forms a sample by sputtering;
an analysis apparatus which performs spectroscopic analysis with respect to a surface of the sample which is film-formed; and
an interrupting member which splits the inner space into a first space where the analysis apparatus is arranged and a second space where the film-forming apparatus is arranged and permits communication between the split first space and second space.

2. The film-forming and analysis composite apparatus according to claim 1,
wherein the film-forming apparatus is further provided with
a substrate holder which holds a target substrate where the sample is film-formed, and
a position adjusting mechanism which changes a position of the substrate holder.

3. The film-forming and analysis composite apparatus according to claim 1,
wherein the interrupting member is a gate valve.

4. The film-forming and analysis composite apparatus according to claim 1,
wherein the analysis apparatus is provided with
an inspection radiation source which irradiates the surface with inspection radiation, and
an electron detector which detects electrons which are released from the surface by the irradiation of the inspection radiation.

5. The film-forming and analysis composite apparatus according to claim 4,
wherein the inspection radiation source is an X-ray source which irradiates X-rays as the inspection radiation, and
the electron detector is a photoelectron detector which detects photoelectrons which are released from the surface by the irradiation of the X-rays.

6. The film-forming and analysis composite apparatus according to claim 4,
wherein the inspection radiation source is an electron gun which irradiates an electron beam as the inspection radiation, and
the electron detector is an Auger electron detector which detects Auger electrons which are released from the surface by the irradiation of the electron beam.

7. The film-forming and analysis composite apparatus according to claim 6,
wherein the analysis apparatus is further provided with a secondary electron detector which detects secondary electrons which are released from the surface by the irradiation of the electron beam.

8. The film-forming and analysis composite apparatus according to claim 1,
wherein the analysis apparatus is further provided with an ion gun which irradiates ions which etch the surface.

9. The film-forming and analysis composite apparatus according to claim 1,
wherein the sample is an oxide semiconductor thin film.

10. A method for controlling the film-forming and analysis composite apparatus according to claim 1, the method comprising:
splitting the space into the first space and the second space before film-forming the sample by sputtering;
film-forming the sample by sputtering in the second space which is formed by the splitting;
producing a vacuum in the second space after the film-forming;
permitting communication between the first space and the second space after the producing of the vacuum; and
performing spectroscopic analysis with respect to the surface of the sample which is film-formed in the space for which communication is permitted by the permitting of the communication.

11. A vacuum chamber which makes an inner space thereof a vacuum, the chamber comprising:
an interrupting member which splits the inner space into a first space where a film-forming apparatus which film-forms a sample by sputtering is arranged and a second space where an analysis apparatus which performs spectroscopic analysis with respect to a surface of the sample which is film-formed is arranged, and permits communication between the split first space and second space.
